(19) United States
(12) Patent Application Publication
(10) Pub. No.: US 2004/0032673 A1
(43) Pub. Date: Feb. 19, 2004

(54) Automobile accident prevention device

(76) Inventor: James V. Morrone, Old Town, ME (US)

Correspondence Address: Mr. JAMES V. MORRONE, LAFAYETTE STATION, P.O. BOX 26, BOSTON, MA, 02112, US

(21) Appl. No.: 10/219,336

(22) Filed: Aug. 16, 2002

(51) Int. Cl. G02B 7/182

(52) U.S. Cl. 359/871

(57) ABSTRACT

An automobile accident prevention device comprising a post-type member and a mirrored-type material attached thereto,

said device used for elimination of roadway blind spots,

said post-type member to be anchored at a novel and unique location adjacent a roadway,

said mirrored-type material to be set on a permanent unmovable angle allowing viewing of oncomming traffic from one vehicle of other oncomming vehicles.

### BACKGROUND OF THE INVENTION

Automobile motorist's have for a long time encountered many blind-spots on the highway's/roadway's, depending on the locations of various obstical's which are part of many intersection's, for instance, many highway intersection's do not provide clear views of oncoming traffic, house's, fence's, commercial building's, ect., may obstruct the motorist's view,

also, on and off highway ramp's are a further example, many times the motorist has to turn his or her head away from the direction of driving to view oncoming traffic, turning away from the normal windshield viewing while the automobile is in motion sometime causes close encounters with other vehicle's or obsticles, mirror's are used on vehicle's to help overcome this problem, however, because the motorist's vehicle is many times in motion, the views from the mirror attached to the vehicle keep changing as the vehicle moves, many driver's are reluctant to depend upon these attached vehicle mirrors, and thus, they look over their sholder for a more positive view,

another frequent occurrence is a trailer-truck, or bus, entering an intersection, stops for a traffic light, and a small compact car pulls up on the side of the truck or bus, in an adjacent lane, and between a sidewalk having a telephone pole on the corner, and the truck or bus making a turn at that corner in the same direction as the adjacent small vehicle, the truck or bus being in the further lane in order for room to occur to maneuver the large vehicle around the corner and avoid hitting the telephone pole, or going up on the sidewalk, a blind spot occurs for the truck or bus driver, and the driver often times does not see the small vehicle and may trap and squash it against the telephone pole as the large vehicle turns the corner,

a further occurrence is when an obsticle prevents a clear view of any oncomming traffic at an intersection, the driver of the vehicle must pull out partly onto the crossing highway in order to view oncomming traffic, and the front of the drivers vehicle is then found to be obstructing oncomming traffic and causing a potentially hazardous situation to occur therefore,

### SUMMARY OF THE INVENTION

it is the object of the present invention to provide that street corners where trucks and buses pass and make turns have a post utilized specifically for securing thereto a mirrored-type material, such as stainless steel which has been polished to the degree that traffic can be viewed in it's reflection, the combination of the post and mirrored-type material attached thereto may also be used at intersections where blind spots occur,

the mirrored-type material comprising means for securing,

said mirrored-type material to be set at a predetermined angle so as to allow an oncomming vehicle operator to view by means of said mirrored-type material other oncomming traffic, thus eliminating the hazardous potential of an accident waiting to occur,

Although mirrors have been used for a variety of purposes, they have not been used for this purpose, and it is for this particular purpose that this idea has been labored over until this solution was finally derived at, and because of this major advancement in highway safety, it would become mandatory that the Highway Department install this accident prevention device, thus eliminating the potential of accidents that would have occurred if this device were not installed,

a further object of the present invention is that the aforementioned post may only require a certain amount of measured feet, seeing that it is only being used for securing mirrored material thereto, and the mirrored-type material may be somewhat less in length than the post, for instance, the post being six feet above the ground, and the mirrored material being long but not wide, the post would be secured by any type of various means to the ground or sidewalk or highway, the post may also be made long enough to accomodate additional mirrored material, for instance for viewing traffic in the opposite direction,

a further object of the present invention is to provide, if desired, a colored cover for the mirrored-type material, such as colored plastic, in order to positively identify the mirrored material as such, whereas night driving may cause the appearance of ones own headlights to be falsely missinterpted as an oncomming vehicle, therefore, the colored cover would assure the viewer that he or she is viewing a mirrored material and not an oncomming vehicle,

the mirrored material itself may be directly colored for this purpose, and even further the colored cover or the directly colored material may also be used to reduce sunshine glare or automotive glare,

a cover may also be used to prevent dirt from collecting on the mirrored material and further scratching the surface of the mirrored material while being cleaned, the cover or material to be cleaned on occasion to provide clear viewing of the mirrored material,

a further object of the present invention is that the post itself may be mirrored, and if so desired by means of more than one side, such as a triangle with two or more sides mirrored which may be required by a particular intersection.

It is further understood that although a metal type material is mentioned for the mirrored-type material, any material suitable may be used.

### BRIEF DESCRIPTION OF THE DRAWINGS

FIG. 1 is a simulated top view of a highway intersection with automobiles at that and approaching that intersection,

a house is located on the left, and a building on the right,

a highway sholder, or space is shown and a mirrored-type material is shown located within the highway sholder or space,

the mirrored material is set on an angle, and viewing lines from each vehicle are illustrated.

FIG. 2 is a front view of the mirrored-type material.

FIG. 3 is a side view of FIG. 2.

FIG. 4 is a front view of the post.

### DETAILED DESCRIPTION OF THE DRAWINGS

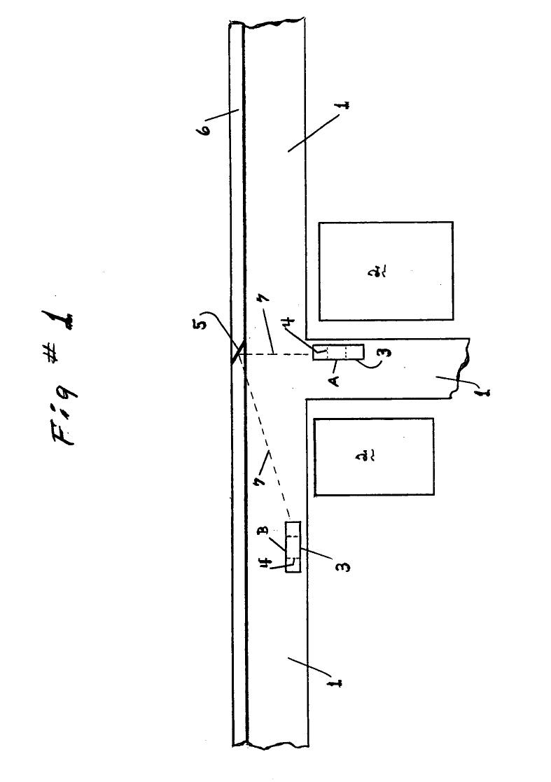

FIG. 1 illustrates a highway intersection, the highway streets are given reference number 1, a house 2 is located on the left, and a building 2 on the right, an automobile 3 A already arrived at the intersection and intending to make a left turn,

the automobile A windshield 4 through which the operator of the vehicle is shown viewing automobile 4 B which has not yet arrived at the intersection,

the viewing is accomplished by means of the operator of automobile A looking at the mirrored-type material 5 and it's reflection of automobile B, a distance away from the intersection is shown in mirror 5 and illustrated by viewing lines 7,

highway sholder, or space 6 is used for securing the post ( not shown) thereto, the mirrored-type material 5 is shown without post in order to eliminate confusion,

the mirrored-type material 5 is set at a predetermined angle and secured to an unmovable post,

it is noted that the windshield and rear window of both vehicles are given reference number 4,

it is further illustrated that vehicle A would be unable to view vehicle B if the mirrored-type material was non-existant, whereas house 2 on left restricts the view through the windshield 4 of vehicle A, and thus would require A to pull out onto the crossing highway 1 in order to view if there were any oncomming traffic, and thus, vehicle A would now be obstructing traffic and causing a potentially hazardous situation to exist, vehicle B would have to stop in time just short of colliding with vehicle A, the illustration presented in FIG. 1 well demonstrates the angled mirrored-type material 5 being secured on sholder or space 6 of highway street 1, as being novel and unique.

FIG. 2 shows the mirrored-type material 5 being long, allowing a full view of any oncomming traffic.

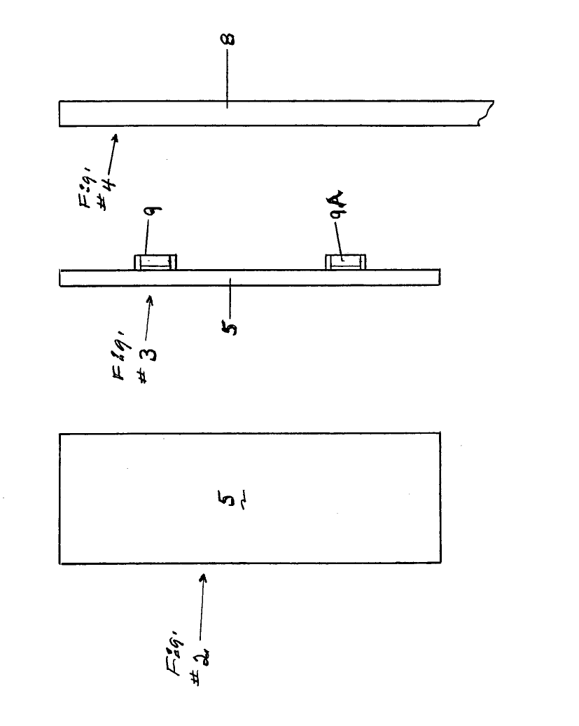

FIG. 3 is a side view of the mirrored-type material 5 and illustrating a type of securing means 9 which may be used for securing the mirrored material to post 8,

although not shown, there are two securing means on top and two on the bottom, four in all,

also, the securing means has an inward angle 9 A used for coinciding with the contour of post 8,

a type of metal strap may be used to pass through the securing means 9 and engage with post 8, thereby being secured thereto,

of course any type of material suitable for use as a strap may be used,

furthermore, other types of securing means may be used, this being only one type.

FIG. 4 shows the post 8 used for holding the mirrored-type material 5 thereto, it is noted that there is a break-away located at the bottom of post 8, whereas the post may be a little longer than the mirrored-type material, an end is not shown, whereas the post may be embedded in the ground, or anchored to a sidewalk.

What is claimed is:

1. An automobile accident prevention device comprising a post-type member and a mirrored-type material,
said post-type member to be used for securing said mirrored-type material thereto,
said post-type member to be anchored and unmovable,
said anchoring to be located at a roadway portion side space adjacent said roadway,
said mirrored-type material to be permanently set on a particular angle for allowing clear viewing of oncomming traffic which would otherwise be unviewable clearly,
said viewing commencing by operator of one vehicle and compleated by said operator viewing said oncomming traffic through said mirrored-type material showing reflection of said oncomming traffic,
said clear viewing of oncomming traffic eliminating previously unviewable clarity or blind spot by means of placement of said device in a novel and unique location which said device is particularly designed for use thereof.

2. An automobile accident prevention device comprising a post-type member and a mirrored-type material,
said post-type member to be used for securing said mirrored-type material thereto,
said post-type member to be anchored and unmovable,
said anchoring to be located at a roadway portion side space adjacent said roadway,
said mirrored-type material to be permanently set on a particular angle for allowing viewing of oncomming traffic which would otherwise be unviewable,
said viewing commencing by operator of one vehicle and compleated by said operator viewing said oncomming traffic through said mirrored-type material showing reflection of said oncomming traffic,
said viewing of oncomming traffic eliminating previously unviewable blind spot by means of placement of said device in a novel and unique location which said device is particularly designed for use thereof.
